(19) United States
(12) Patent Application Publication
(10) Pub. No.: US 2014/0358704 A1
(43) Pub. Date: Dec. 4, 2014

(54) SECURED POINT-OF-SALE TRANSACTIONS

(71) Applicant: IDMission LLC, Boulder, CO (US)

(72) Inventors: Ashim Banerjee, Boulder, CO (US); Sandeep Gandhi, San Ramon, CA (US); Angela Schmuck, Mesa, AZ (US)

(21) Appl. No.: 13/907,314

(22) Filed: May 31, 2013

(51) Int. Cl. G06Q 20/40; G06Q 20/20

(52) U.S. Cl. CPC G06Q 20/405; G06Q 20/20
USPC 705/16; 705/39; 705/44

(57) ABSTRACT

Systems, devices, and methods for secure transaction processing are provided. A point-of-transaction device may receive a selection of transaction parameters to establish and store a security rule. The point-of-transaction device may then receive a transaction request and confirm that the transaction request complies with the security rule. The point-of-transaction device may forward the security rule and the transaction request to a transaction security server that stores the security rule and further verifies that the transaction request complies with the security rule. The transaction security server may also forward at least a portion of the transaction request to a third party that further confirms an identity of the customer.

### BACKGROUND

The present invention relates to secured point-of-sale transaction systems and methods that permit a user to create security rules locally that can be applied to transactions.

Transactions are an integral component of virtually every economy. Exemplary transactions may include, but are not limited to, purchases, money transfers, deposits, prepaid cards, mobile connections, etc. For each transaction, the user (e.g., agent, retailer, bank, service provider, etc.) can be faced with competing interests. On one hand, there is a need for the user to provide a satisfactory experience for the customer. On the other hand, financial considerations and legal requirements favor the prevention of fraud, identity theft, money laundering, and the like, when conducting transactions.

For some cash-based transactions, standard security procedures do not require proof of identity of the customer and/or the customer's identity is not obtained, verified, or otherwise associated with the transaction. For other transaction types (e.g., credit/debit card and/or cash-based transactions) where identification of the customer may be obtained, the customer's identity is not always confirmed and/or associated with the transaction. For example, the user may request some form of identification from the customer during a transaction. Typically, the user uses the proffered identification to confirm that the proof of identification corresponds to the customer, e.g., has the same name as appears on a credit card being used by the customer. However, the user typically cannot confirm that the proof of identification provided by the customer is authentic.

Furthermore, the user is typically limited to security rules established by, for example, credit card issuing companies. As is understood, a credit card issuing company typically establishes a rule that no identification is required for card-based transactions below a de minimis dollar amount. Beyond that dollar amount, the company requires a signature or a personal identification number (PIN) to serve as the customer's identification component. The user can request some form of identification to confirm that the signatures/name matches. However, such credit card issuing company rules do not help the user prevent fraud when the transaction is cash-based and, further, do not permit the user to establish its own security rules that can be applied to transactions of varying amounts or types.

Thus, there is a need to permit the user to establish security rules that can be applied to transactions and, in some instances, to confirm the identification of the customer to the transaction.

### SUMMARY

In one set of illustrative embodiments, a method of conducting transactions may include receiving, at a point of transaction device, a selection of a transaction type, a selection of a triggering transaction amount, and a selection of at least one transaction parameter; storing a security rule associating the at least one transaction parameter with the selected transaction type and the selected triggering transaction amount; receiving a transaction request matching the transaction type and satisfying the triggering transaction amount; and selectively forwarding at least a portion of the transaction request to a transaction security system based on a determination of whether the transaction request complies with the security rule.

According to a second set of illustrative embodiments, a method of conducting a transaction may include receiving a transaction security configuration, the transaction security configuration based at least in part on one or more predefined transaction parameters; receiving a transaction request comprising information identifying at least one transaction parameter; comparing the transaction request to the transaction security configuration; and forwarding at least a portion of the transaction request to a third party based on the comparison of the transaction request to the transaction security configuration.

According to a third set of illustrative embodiments, an apparatus for conducting transactions may include a processor; memory in electronic communication with the processor; and instructions being executable by the processor to, receive, at a point of transaction device, a selection of a transaction type, a selection of a triggering transaction amount, and a selection of at least one transaction parameter; store a security rule associating the at least one transaction parameter with the selected transaction type and the selected triggering transaction amount; receive a transaction request matching the transaction type and satisfying the triggering transaction amount; and selectively forward at least a portion of the transaction request to a transaction security system based on a determination of whether the transaction request complies with the security rule.

According to a fourth set of illustrative embodiments, an apparatus for conducting transactions may include a processor; memory in electronic communication with the processor; and instructions being executable by the processor to, receive a transaction security configuration, the transaction security configuration based at least in part on one or more predefined transaction parameters; receive a transaction request comprising information identifying at least one transaction parameter; compare the transaction request to the transaction security configuration; and forward at least a portion of the transaction request to a third party based on the comparison of the transaction request to the transaction security configuration.

According to a fifth set of illustrative embodiments, system for conducting transactions may include a point of transaction device configured to receive selections of a transaction type, a triggering transaction amount, and at least one transaction parameter, to store a security rule associating the transaction parameter with the selected transaction type and the selected triggering transaction amount, to receive a transaction request matching the transaction type and satisfying the triggering transaction amount, and to forward the transaction request; and a transaction security server configured to receive the transaction request and the security rule, to determine whether the transaction request complies with the security rule, and to forward at least a portion of the transaction request to a third party based on the comparison.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a diagram illustrating an exemplary communication flow between components configured according to various embodiments of the invention.

FIG. 3 is a diagram of another exemplary communication flow between components configured according to various embodiments of the invention.

FIG. 4 is a diagram of another exemplary communication flow between components configured according to various embodiments of the invention.

FIG. 5 is a block diagram of an example of a transaction security server according to various embodiments of the invention.

FIG. 6 is a block diagram of another example of a transaction security server according to various embodiments of the invention.

FIG. 7 a block diagram of an example of a point-of-transaction device according to various embodiments of the invention.

FIG. 8 is a block diagram of another example of a point-of transaction device according to various embodiments of the invention.

FIG. 9 is a flowchart diagram of an example method of establishing a transaction security rule according to various embodiments of the invention.

FIG. 10 is a flowchart diagram of another example method of establishing a transaction security rule according to various embodiments of the invention.

FIG. 11 is a schematic diagram that illustrates a representative device structure that may be used in various embodiments of the present invention.

### DETAILED DESCRIPTION OF THE INVENTION

Methods, systems, and devices are disclosed for a user to establish a security rule, or a security configuration including a plurality of security rules, that are applied during transactions to provide a secured point-of-sale transaction. The systems may include a point-of-transaction device in operative communication with a transaction security server. According to certain embodiments, the point-of-transaction device receives a selection of certain transaction parameters and, based on the selected transaction parameters, establishes and stores a security rule. In one example, the transaction parameters may include a selection of a transaction type, a selection of a triggering transaction amount, and a selection of at least one additional transaction parameter. The at least one transaction parameter may comprise a selection of a predetermined security level response associated with the transaction, e.g., what steps the user must follow for a given transaction type/amount to ensure security. Exemplary security rules include, but are not limited to, a requirement for a customer's signature for a cash-based transaction up to a first transaction amount, a requirement to capture an image of the customer for a card-based transaction up to a second transaction amount, a requirement to capture an additional biometric parameter from the customer for a cash or card-based transaction up to a third transaction amount, and the like. The point-of-transaction device may store the security rules and then apply the security rules to each transaction, i.e., may require certain security steps based on the transaction.

The point-of-transaction device may communicate the security rule, and/or a security configuration including multiple security rules, to the transaction security server where the server stores the security rule/configuration. The point-of-transaction device may then receive a transaction request that matches the transaction type and satisfies the triggering transaction amount, i.e., is of the same transaction type and for at least the minimum triggering amount for that transaction. The point-of-transaction device may apply the security rule locally or forward at least a portion of the transaction request to the transaction security system based on the transaction request complying with the matched security rule. The transaction security system may determine or confirm that the transaction request complies with the matched security rule and, if so, forward at least a portion of the transaction request to a third party.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the terms “user(s)” and “customer(s)” generally refer to the parties to a transaction. By way of example only, a user may be an individual, an agent, a bank teller, a service provider, a brick-and-mortar business, etc. In some situations, the user may be the party to the transaction that provides certain goods and/or services being exchanged during the transaction. The customer may be an individual, representative of a company, a group of individuals, etc. In some situations, the customer is the party to the transaction that seeks to receive the goods and/or services being provided by the user. According to one example, the user may be an agent at a money transfer business where the customer is an individual seeking to transfer money. According to another example, the user may be an agent of a government agency charged with distributing government subsidies where the customer is an individual seeking to receive the subsidies. According to a third example, the user is an agent or clerk at a retail store and the customer is an individual consumer.

As used herein, the term “transaction” refers to any exchange between a user and a customer. The transaction may be monetary or non-monetary based. The transaction may be for money, for products, for services, for information, etc. According to some examples, the transaction may be a one-way transaction, e.g., a money transfer exchange where the customer provides money to an agent to be transferred to a different location. In that instance, a second user and customer may complete another transaction at the remote location. Furthermore, a transaction is not limited to a single user and/or a single customer.

Systems, devices, methods, and software are described for secure transaction processing in a system of networked devices.

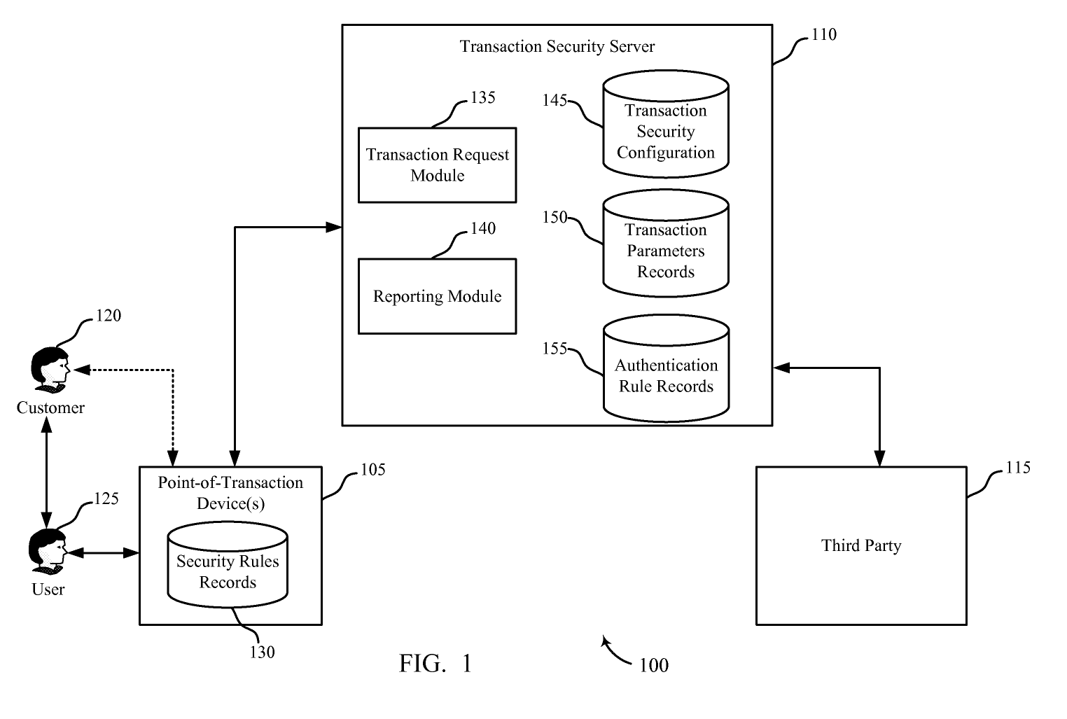

FIG. 1 illustrates an example system 100 configured for conducting secured point-of-sale transactions according to embodiments of the present disclosure. The system 100 includes a point-of-transaction device(s) 105, a transaction security server 110, and a third party 115. Each of these components may be in communication, directly or indirectly, via one or more of a wired and/or a wireless communications channel.

In the example of FIG. 1, the point-of-transaction device 105 is located proximate a customer 120 and/or a user 125. For example, the point-of-transaction device 105 may be located in a business establishment operated by the user 125. Generally, the point-of-transaction device 105 may be configured to permit the user 125 to input, capture, transmit, and/or receive selections related to the establishment of security rules as well as additional parameters related to the transaction. For instance, the point-of-transaction device 105 may be configured to permit the user to input, capture, or otherwise receive selections of a transaction type, a selection of a triggering transaction amount, and/or a selection of at least one transaction parameter. The point-of-transaction device may also be configured to store a security rule that associates the at least one transaction parameter with the selected transaction type and the selected triggering transaction amount.

The transaction type may include information or data indicative of whether the transaction is a cash-based transaction, a card-based transaction (e.g., where the customer is paying using a credit or debit card), an exchange of goods or services transaction, or another transaction type. The triggering transaction amount may include information or data indicative of the monetary amount involved in the transaction (e.g., the dollar amount) or some other information indicative of the item/service being exchanged during the transaction. A transaction does not necessarily involve the exchange of monetary funds. According to one example, the transaction may be for the distribution of items to individuals. In that example, the transaction amount may refer to the quantity of items being distributed to the customer 120. Accordingly, the triggering transaction amount may include information or data indicative of the amount or worth of the items/services being exchanged in the transaction. The at least one transaction parameter may include information or data indicative of an action or response that is to be initiated for a given transaction type and/or triggering transaction amount. For example, the at least one transaction parameter may include information requiring capture of a signature of the customer, capturing an image of the customer, capturing biometric data from the customer, capturing an image of an identification card from the customer, and the like.

Accordingly, the user 125 can utilize the point-of-transaction device 105 to establish a wide variety of security rules to be applied to differing transactions. As one example, the user can select applicable transaction parameters to establish a security rule where an image of the customer is captured for every cash-based transaction, regardless of the transaction amount. As another example, the user can select applicable transaction parameters to establish security rules where the at least one transaction parameter captured from the customer becomes progressively more restrictive as the triggering transaction amount increases. As an even further example, the user can select applicable transaction parameters to establish a security rule where biometric data is captured from the customer during the transaction, communicated to the transaction security server for verification, and a confirmation signal is received from the transaction security server before approving the transaction. Other security rules can be selected and established based on the needs of the user 125, legal requirements, developing business practices, and the like. As can be appreciated, the user 125 can establish a wide variety of differing security rules that vary based on the selection of, for example, the type of transaction, the value involved in the transaction, developing industry standards, and the like. As can be further appreciated, the user 125 can dynamically edit, delete, or establish security rules dependent on varying business or social conditions. Thus, the user 125 is provided a great deal of flexibility to establish security rules that favor the prevention of fraud, theft, and the like.

The point-of-transaction device 105 may also be configured to permit the user 125 to input or capture an identification parameter from the customer. The identification parameter may be included as a part of the transaction request and be collected from the customer 120 as a part of the transaction. The identification parameter may identify the customer that is a party to the transaction. As indicated by the dashed line, certain embodiments permit the customer 120 to input some of the parameters associated with the transaction into the point-of-transaction device 105. The identification parameter may be any information captured from the customer 120 during the transaction. For example, the point-of-transaction device 105 may be configured to capture an image, a voice print, a fingerprint, or any other form of biometric data from the customer 120 contemporaneous to the transaction. Also, or alternatively, the point-of-transaction device 105 may be configured to capture an image of an identification card provided by the customer 120 as proof of identity, e.g., an image of the customer 120's drivers license, government issued identification card, etc.

Once the user 125 has established the security rules, the point-of-transaction device 105 may be configured to, as the user 125 and/or customer 120 enters parameters associated with the transaction, determine which of the security rule(s) established by the user 125 applies to that transaction and prompt the user 125 and/or customer 120 for the appropriate compliance measures. As one example, if a security rule input by the user 125 requires an image of the customer for cash-based transactions over $100.00, once the point-of-transaction device 105 determines that the transaction is a cash-based transaction for an amount in excess of the triggering transaction amount, the point-of-transaction device 105 may prompt the user 125 and/or customer 120 to capture an image of the customer 120 before proceeding with the transaction. Once the image of the customer 120 has been captured, the point-of-transaction device 105 may be configured to permit the user 125 to finalize the transaction.

Furthermore, the point-of-transaction device 105 is communicatively coupled to the transaction security server 110 via one or more of a wired and/or a wireless communication channel. For instance, the point-of-transaction device 105 may communicate the security rule to the transaction security server 110 and also communicate the request for the transaction to the transaction security server 110 via at least one of the communications channels.

The transaction security server 110 may include a transaction request module 135, a reporting module 140, a transaction security configuration records 145, transaction parameters records 150, and authentication rule records 155. Each of these components may be communicatively coupled via, for example, a common bus or other communications channel. The transaction security server 110 may be communicatively coupled with a number of point-of-transaction devices 105 (only one being shown in FIG. 1 for clarity) and the third party 115. Broadly, the transaction security server 110 may be configured to receive the security rules and the transaction request from the point-of-transaction device 105, store the security rule in the security configuration records 145, authenticate or otherwise confirm the identity of the customer based on the identification parameter, determine whether the transaction request complies with the applicable security rule, and return confirmation signal to the point-of-transaction device 105. The transaction security server 110 may be implemented by a single server device or by a number of related components interconnected over a network.

The transaction security configuration records 145 may be electronic records stored in memory and including information related to one or more security rules for each of the point-of-transaction devices 105. As one example, the transaction security configuration records 145 may include information relating to different security rules for each point-of-transaction device 105 and/or a set of security rules that are applicable to a plurality of point-of-transaction devices 105. Thus, the transaction security configuration records 145 may store the security rules established by the user 125 at the point-of-transaction device 105.

The transaction parameter records 150 may be electronic records stored in memory and including information related to a plurality of transaction parameters. These transaction parameters may include data identifying the customer 120 associated with a transaction request. Examples of transaction parameters include, but are not limited to, one or more images of the customer, other biometric information related to the customer 120 (e.g., facial recognition data, fingerprint data, retinal scan data, etc.), images of identification documents of the customer 120 (e.g., drivers license images, proof of address images, etc.), or other information related to the customer 120 associated with the transaction. One or more security rules stored in the transaction security configuration records 145 may be established for a transaction or transaction type, and may specify one or more transaction parameters that are to accompany a valid transaction request. As transaction requests are received at the transaction security server 110, the transaction parameters received with the transaction requests may be stored in the transaction parameters records 150 and indexed according to customer identifier codes.

For example, a security rule may specify that, for a given transaction type and/or amount, an image of the customer and/or an image of the customer's identification card must accompany the transaction request. In this example, the transaction request may further include a customer identifier code. Using the customer identifier code, the transaction security server 110 may query the transaction parameters records 150 to retrieve an address, telephone number, date of birth, etc, for the customer 120, as well as a previously captured image of the customer. These previously stored transaction parameters, in conjunction with the new transaction parameter(s) provided with the transaction request (i.e., an image of the customer 120 taken in connection with the current transaction) may be used to authenticating the customer and approve the transaction.

According to further embodiments, when the transaction parameters records 150 do not have a record stored for a customer 120 identified in a transaction request, the transaction security server 110 may be configured to create and store a record for that customer 120 as a part of an initial registration process (e.g., during the first transaction conducted with a given customer identification code).

The authentication rule records 155 may be electronic records stored in memory and including information related to predetermined rules for given transactions. Generally, it can be appreciated that restrictions exist relating to certain transaction types, amount, frequency, etc. For example, certain rules may prohibit or control the transfer of currency, or a predetermined amount of currency, in to or out of a particular geographic region. Other rules may prohibit or control the ability of certain customers 120 to participate in some transactions (e.g., prohibit a convicted felon from purchasing a gun). Even further, some rules may limit the frequency of transactions for a particular customer 120 within a given time period (e.g., the number of times a customer 120 may be distributed certain items or provisions). The authentication rule records 155 include information relating to such transaction rules which can be utilized for each transaction as an additional form of transaction security and fraud prevention.

Each of the records 145, 150, and/or 155 may be stored in memory, in one or more database(s), etc., either locally or remotely from the transaction information system 100.

The transaction request module 135 may include logic, hardware, and the like to receive the security rule and store the security rule, associated with the point-of-transaction device 105, in the transaction security configuration records 145. The transaction request module 135 may also receive the transaction request from the point-of-transaction device 105 and access the transaction security configuration to retrieve the security rule associated with the point-of-transaction device 105 as well as the applicable at least one transaction parameter. According to some embodiments, the transaction request module 135 may compare certain of the retrieved information with the information contained in the transaction request to confirm that the transaction request complies with the security rule. For instance, if the transaction amount at least meets the triggering transaction amount from the security rule and the at least one transaction parameter requires an identification parameter that is an image of the customer that is to be verified, the transaction request module 135 may retrieve an image associated with the customer from the transaction parameters records 150 and compare the images to confirm the customer's identity and, thus, that the transaction request complies with the security rule. Other aspects may provide for the confirmation based on fingerprint comparison. If the transaction request module 135 cannot confirm the identity of the customer, the transaction request module 135 may reject that transaction or flag the transaction for manual review for identity confirmation.

As discussed, some embodiments may provide for the transaction request module 135 to access records from the authentication rule records 155 to determine whether the customer 120 is authorized to engage in the transaction. As one example, if the transaction parameters records 150 indicate that the customer 120 has engaged in similar transaction types within a predetermined time period and the authentication rules records 155 indicate that a given customer is only permitted to engage in that type of transaction a predetermined number of times within the time period, the transaction request module 135 may determine that the customer 120, even though their identity has been confirmed, is rejected for that transaction.

Other embodiments may provide for the transaction security server 110 to communicate with the third party 115 to confirm the identity of the customer 120. That is, the transaction request module 135 may communicate information associated with the customer 120 along with the identification parameter to the third party 115. According to some embodiments, the third party 115 accesses the information on the transaction security server 110 via a series of web pages, for example, to confirm the identity of the customer 120. The third party 160 may review the information and, in some instances, additional information maintained by the third party 160, to confirm the identity of the customer 120.

Once the identity of the customer 120 has been confirmed and, when applicable, the customer 120 has been determined eligible for the transaction, the transaction security server 110 communicates a confirmation signal to the point-of-transaction device 105.

The reporting module 140 may be configured to generate one or more reports relating to the records stored by the transaction security server 110. Exemplary reports may be for a particular customer 120, for a particular user 125, for a particular transaction type, for a particular transaction security rule, may be based on one or more predetermined time periods, and the like. In other embodiments the reporting module 140 is configured to dynamically generate custom reports or store one or more predefined reports that can be retrieved. The transaction security server 110 may communicate the reports to, for example, the third party 115, the user 125, and/or the customer 120. Other aspects provide for the transaction security server 110 to make the reports available via a series of one or more web pages accessible using a web browser.

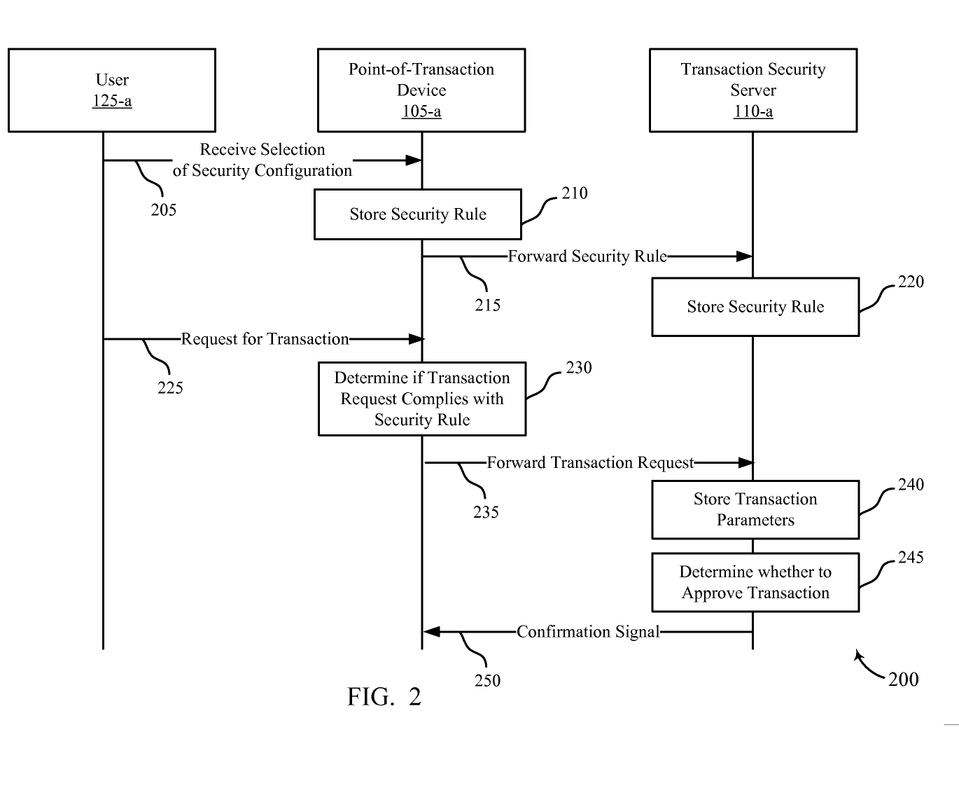

FIG. 2 is a diagram illustrating an exemplary communication flow 200 for secure transaction processing in accordance with various embodiments. Communication flow 200 may be used, for example, by the point-of-transaction device 105, the transaction security server 110, and the third party 115 of FIG. 1 for secure transaction processing.

At 205, point-of-transaction device 105-a receives a selection of transaction parameters, from the user 125-a. The transaction parameters may include a transaction type, a triggering transaction amount, and at least one transaction parameter. The point-of-transaction device 105-a may be configured to create a security rule that associates the at least one transaction parameter with the transaction type and the triggering transaction amount. At 210, the point-of-transaction device 105-a stores the security rule. For example, the point-of-transaction device 105-a may store the security rule as a record in the security rules records 130. As discussed, the point-of-transaction device 105-a may apply the security to rule to subsequent transaction requests that matches the transaction type and/or the triggering transaction amount. As applied, the point-of-transaction device 105-a may be configured to prompt the user 125-a and/or customer 120 to capture certain information from the customer 120 prior to completing the transaction, e.g., capture an image of the customer. At 215, the point-of-transaction device 105-a communicates the security rule to the transaction security server 110-a. The transaction security server 110-a stores the security rule at 220.

At 225, the user 125-a communicates a request for a transaction to the point-of-transaction device 105-a. The user 125-a may, for example, scan a barcode of an item being purchased by the customer as well as input information indicating whether the transaction is to be cash or card-based (e.g., by swiping the customer's credit card or pressing a cash button). At 230, the point-of-transaction device 105-a determines if the transaction request complies with the security rule. For example, the point-of-transaction device 105-a determines if the transaction amount/type match a triggering transaction amount and/or type and, if so, determines whether the associated security response has been met (as indicated by the associated at least one transaction parameter).

At 235, the point-of-transaction device 105-a may forward at least a portion of the transaction request to the transaction security server 110-a. As can be appreciated, the transaction request may be forwarded to the transaction security server 110-a as an additional form of security. For example, the user 125-a and the customer 120 were mischievous collaborators, the user 125-a may input to the point-of-transaction device 105-a that the security rule requirement had been met, even though the image of the customer was not actually captured. Forwarding the transaction request to the transaction security server 110-a may provide an additional verification that the security rule requirements have been satisfied, that the identity of the customer has accurately been captured, and may even provide for authentication of the customer's identity.

Thus, at 240, the transaction security server 110-a may store one or more transaction parameters associated with the transaction request (e.g., the transaction parameters specified by the applicable security rule(s)), and at 245, the transaction security server 110-a may determine whether to approve the transaction. The approval of the transaction may be based, for example, on a determination of whether the applicable security rule(s) for the transaction have been satisfied. Additionally or alternatively, the approval of the transaction may be based on an authentication of the customer's identity based on the transaction parameters received with the transaction request and/or previously stored transaction parameter received or obtained by the transaction security server 110-a in connection with previous transactions conducted by the customer.

At 250, the transaction security server 110-a communicates a confirmation signal to the point-of-transaction device 105-a indicating that the transaction is authorized and the security rule has been complied with. Accordingly, the point-of-transaction device 105-a completes the transaction between the user and the customer.

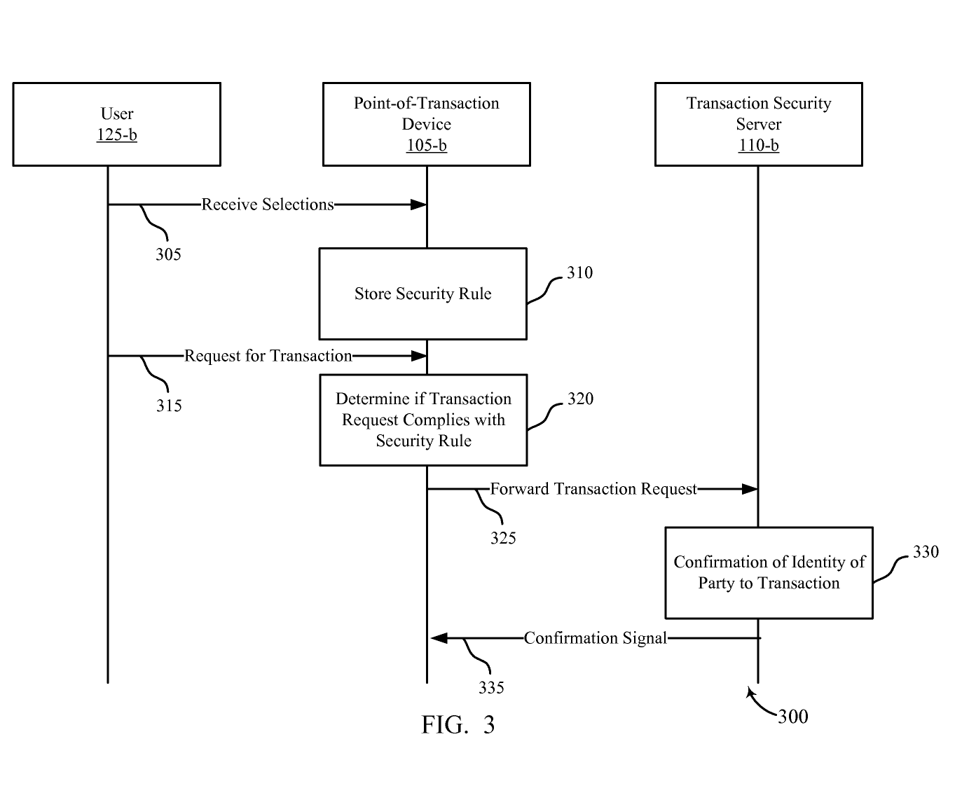

FIG. 3 is a diagram illustrating an exemplary communication flow 300 for secure transaction processing in accordance with various embodiments. Communication flow 300 may be used, for example, by the user 125, the point-of-transaction device 105, and the transaction security server 110 of FIG. 1 for secure transaction processing. Generally, the communication flow 300 illustrates the circumstance where the transaction security server 110-b confirms, in whole or in part, the identity of the customer.

At 305, point-of-transaction device 105-b receives a selection of transaction parameters, from the user 125-b. The transaction parameters may include the transaction type, the triggering transaction amount, and the at least one transaction parameter where the point-of-transaction device 105-b creates a security rule that associates the at least one transaction parameter with the transaction type and the triggering transaction amount. At 310, the point-of-transaction device 105-b stores the security rule in security rules records 130, for example. At 315, the point-of-transaction device 105-b receives a request for a transaction from the user 125-b. The transaction request may include a transaction amount, a transaction type, a customer identifier code identifying the customer to the transaction, and the like. The transaction request may further include an identification parameter of the customer that is captured in response to the security rule requirements. For instance, if the security rule requires an image of the customer for a given transaction amount/type, at least a portion of the transaction request may include capturing the customer's image and including the image in the transaction request. At 320, the point-of-transaction device 105-b determines if the transaction request complies with the security rule. For example, the point-of-transaction device 105-b may be configured to ensure that for a transaction amount that matches the triggering transaction amount and for a type of transaction that matches the transaction type, that the appropriate security requirement identified by the at least one transaction parameter has been complied with. If the transaction request complies with the security rule, the point-of-transaction device 105-b communicates at least a portion of the transaction request to the transaction security server 110-b.

At 330, the transaction security server 110-b authenticates or confirms the identity of the party to the transaction. As discussed, the transaction request may include a customer identifier code that is associated with the customer. The transaction security server 110-b may access one or more records storing information for the associated customer. Utilizing the information retrieves from the stored records, the transaction security server 110-b may compare the retrieved information with the identification parameter from the transaction request to confirm the identity of the customer. As one example, the identification parameter may be an image of the customer and the retrieved information may include a different image of the customer. In that example, the transaction security server 110-b may compare the images, using a facial recognition algorithm for example, to confirm the customer's identity. It is to be understood that the customer's identity may be confirmed based on the customer's fingerprint, based on images of the customer's identification card, and the like. At 335, the transaction authority 115-b communicates a confirmation signal to the point-of-transaction device 105-b indicating that the customer's identity has been confirmed and the transaction is approved.

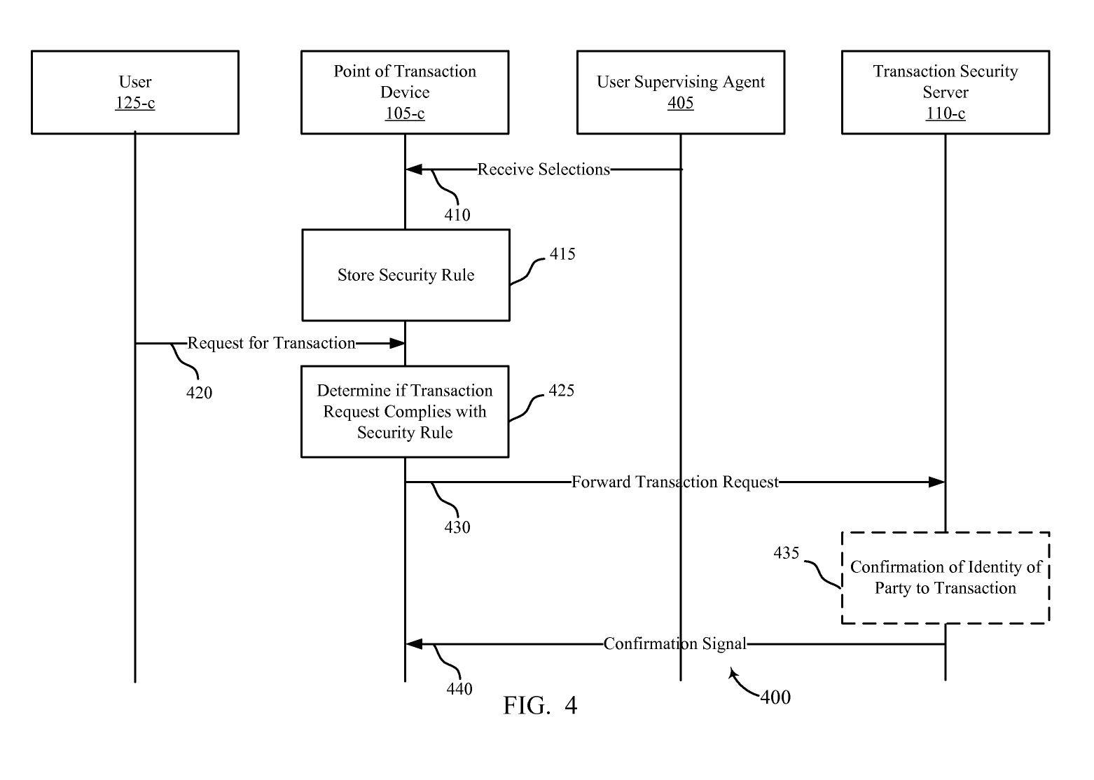

FIG. 4 is a diagram illustrating an exemplary communication flow 400 for secure transaction processing in accordance with various embodiments. Communication flow 400 may be used, for example, by the user 125, the point-of-transaction device 105, and the transaction security server 110 of FIG. 1 for secure transaction processing. Generally, the communication flow 400 illustrates the circumstance where a supervising agent 405 of the user 125-c determines the transaction parameters used to establish the security rule that are applicable to the user's point-of-transaction device. It is to be understood that the user supervising agent 405 is separate from the transaction security server 110-c, but is, at least to some degree, associated with the user 125-c utilizing the point-of-transaction device 105-c.

At 410, the point-of-transaction device 105-c receives the transaction parameters from the user supervising agent 405. According to some embodiments, the user supervising agent 405 may be an individual, a corporation, an agency, and the like, that is associated with the user 105-c. As one example, the user supervising agent 405 may be a corporate headquarters for a given company where multiple users 125-c may be individual locations operating under the company name and providing services to customers, e.g., each user 125-c may be a chain or franchise of the user supervising agent 405. According to another example, the user supervising agent 405 is a government agency providing a product/service where each user 125-c is a geographical office acting under the direction of the agency. As can be appreciated, the user supervising agent 405 is separate from the transaction security server 110-c and permits the corporate headquarters or government agency to customize their own security rules based on their individual needs. Accordingly, the user supervising agent 405 distributes the selections necessary to establish the security rules to each user 125-c (via the point-of-transaction device 105-c) to thereby set the security rules for each of its users. As such, the user supervising agent 405 maintains the discretion and ability to determine appropriate security rules rather than being limited to the security rules dictated by the credit card issuing companies, for example.

At 415, the point-of-transaction device 105-c stores the security rule in security rules records 130, for example. At 420, the point-of-transaction device 105-b receives a request for a transaction from the user 125-c. The transaction request may include a transaction amount, a transaction type, a customer identifier code identifying the customer to the transaction, as well as the identification parameter. At 425, the point-of-transaction device 105-c determines if the transaction request complies with the security rule, such as described above. If the transaction request complies with the security rule, the point-of-transaction device 105-c communicates at least a portion of the transaction request to the transaction security server 110-c.

At 435, the transaction security server 110-c optionally authenticates or confirms the identity of the party to the transaction. As discussed, the transaction security server 110-c may simply confirm that the transaction request complies with the security rule and, in some examples, store information associating the customer's identity with the transaction. According to other examples, the transaction security server 110-c may utilize a customer identifier code associated with the customer to query records to retrieve additional information associated with the customer. The transaction security server 110-c may utilize this information to confirm the identity of the customer before approving the transaction. At 440, the transaction security server 110-c communicates a confirmation signal to the point-of-transaction device 105-b indicating that the customer's identity has been confirmed and the transaction is approved.

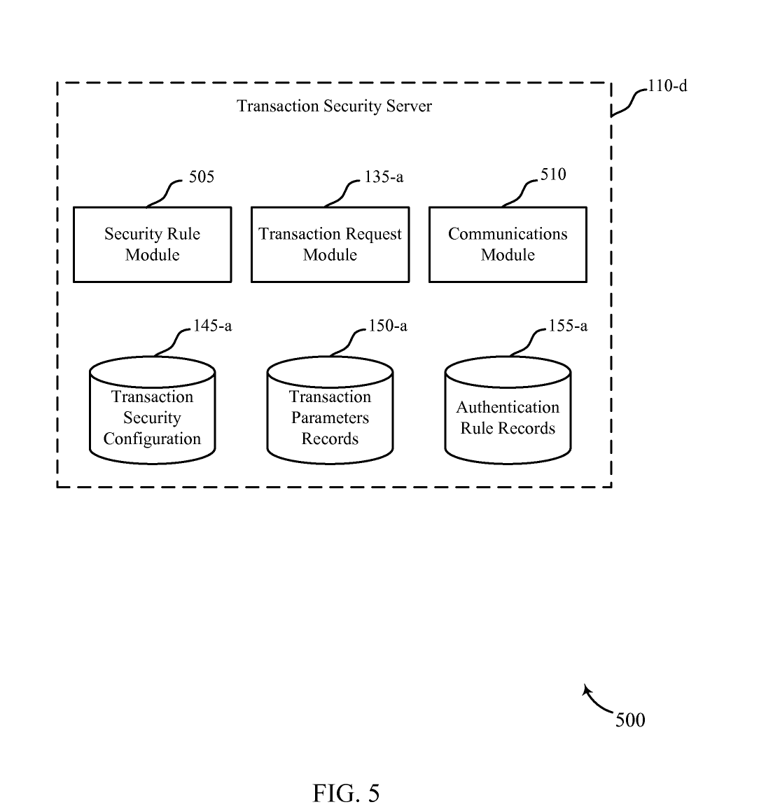

FIG. 5 is a block diagram 500 of an example transaction security server 110-d for secure transaction processing in accordance with various embodiments of the present disclosure. The transaction security server 110-d may implement aspects and/or components of the transaction security servers 110 of FIGS. 1-4 as well as implementing aspects of communication flows 200, 300, and/or 400. The transaction security server 110-d may be implemented in whole, or in part, as a processor.

Transaction security server 110-d includes a security rule module 505, a transaction request module 135-a, a communications module 510, a transaction security configuration records 145-a, a transaction parameters records 150-a, and an authentication rule records 155-a, which each may be in communication, directly or indirectly, with each other. The communications module 510 is configured to communicate via one or more communications channel(s). The one or more communications channels may be wired, wireless, or a combination of wired and wireless communications channels. The communications module 510 is configured to permit the transaction security server 110-d to operatively communicate with the point-of-transaction device 105 and/or the third party 115. The communications module 510 may communicate with the point-of-transaction device 105, for example, via a first communications channel (e.g., wirelessly via a cellular network) and communicate with the third party 115 via a second communications channel (e.g., wired via the Internet).

The security rule module 505 is configured to receive the security rule, or the security configuration from the point-of-transaction device 105 and store the security rule in the transaction security configuration records 145-a. Accordingly, the transaction security server 110-d may store each security rule associated with a particular point-of-transaction device 105. The transaction request module 135-a is configured to receive the transaction request from the point-of-transaction device 105 (via the communications module 510). The transaction request may include the transaction amount, the transaction type, and the identification parameter that may be captured contemporaneously with the transaction. The transaction parameters records 150-a may include an address, telephone number, date of birth, etc, for the customer as well as a previously captured image of the customer associated with the customer identifier code included in the transaction request. Additionally, or alternatively, the transaction parameters records 150 may include biometric information related to the customer associated with the customer identifier code, e.g., an image of the customer, a fingerprint of the customer, etc. As previously discussed, the authentication rule records 155-a may include electronic records stored in memory including information associated with differing rules pertaining to given transactions, e.g., rules for the prevention of money laundering.

The transaction request module 135-a may communicate with the transaction security configuration record 145-a to determine whether the transaction request complies with the stored security rule, e.g., whether the at least one transaction parameter complies with the associated triggering transaction amount and transaction type. According to certain embodiments, the transaction request module 135-a may also communicate with the transaction parameters records 150-a to retrieve additional information associated with the customer identifier code, e.g., address, contact information, image, and the like. The transaction request module 135-a may be configured to utilize the customer identifier code, the identification parameter, and the additional information retrieved from the transaction parameters records 150-a to authenticate (or confirm) the identity of the customer. According to certain embodiments, the transaction request module 135-a may be configured to query the authentication rules records 155-a to determine whether the identified customer is authorized to engage in the transaction.

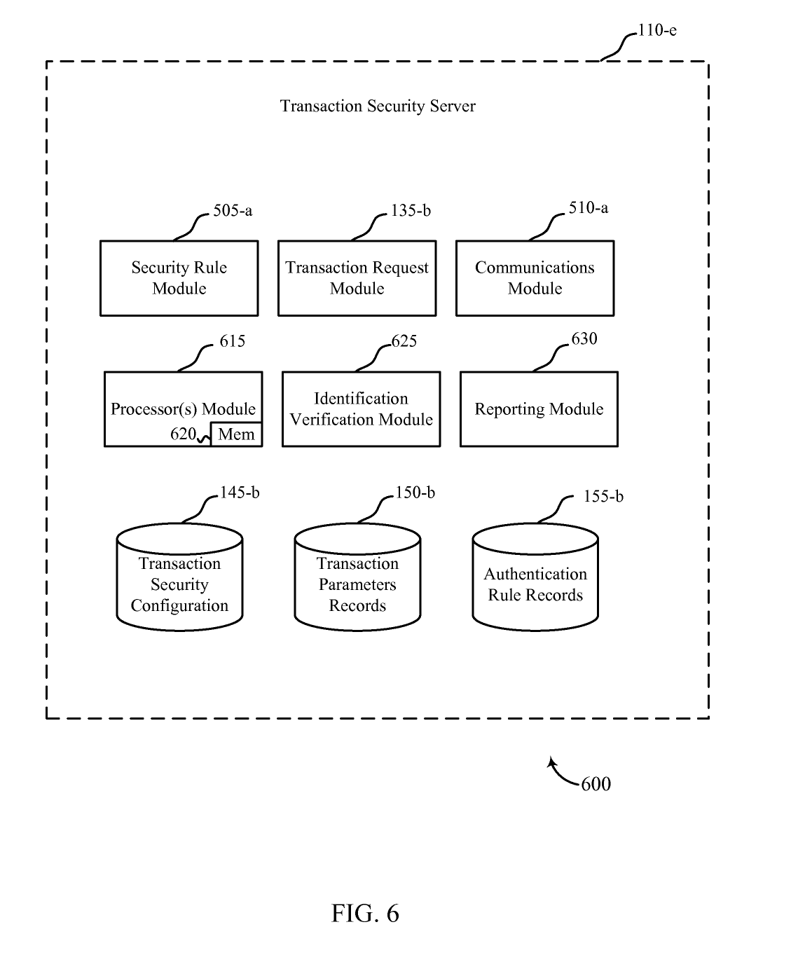

FIG. 6 a block diagram 600 of another example transaction security server 110-e for secure transaction processing in accordance with various embodiments of the present disclosure. The transaction security server 110-e may implement aspects and/or components of the transaction security servers 110 of FIGS. 1-5 as well as implementing aspects of communication flows 200, 300, and/or 400. Aspects of the transaction security server 110-e may be a processor.

Transaction security server 110-e includes a security rule module 505-a, a transaction request module 135-b, a communications module 510-a, a processor module 615, an identification verification module 625, a reporting module 630, a transaction security configuration records 145-b, a transaction parameters records 150-b, and an authentication rule records 155-b, which each may be in communication, directly or indirectly, with each other. The communications module 510-a may be configured to communicate via one or more communications to transmit and receive various information for secure transaction processing. The security rule module 505-a may be configured to receive the security rule or security configuration from the point-of-transaction device 105 and store the security rule in the transaction security configuration records 145-b. The transaction request module 135-b may be configured to receive the transaction request including the parameters associated with the transaction and also the identification parameter. The modules 505-a and/or 135-b may be configured to query one or more of the records 145-b, 150-b, and/or 155-b to (1) determine whether the transaction request complies with the applicable security rule, (2) retrieve additional information for the customer associated with the customer identifier code, (3) verify the identity of the customer based on the additional information and the identification parameter, and (4) communicate a confirmation signal to the point-of-transaction device 105 indicating that the transaction is in compliance and that the customer's identity has been confirmed.

The processor module 615 includes a memory 620. The memory 620 may include random access memory (RAM) and read-only memory (ROM). The memory 620 may store computer-readable, computer-executable software code containing instructions that are configured to, when executed, cause the processor module 615 to perform various functions described herein (e.g., transaction processing). Alternatively, the software may not be directly executable by the processor module 615 but may be configured to cause a computer (e.g., when compiled and executed) to perform functions described herein. The processor module 615 may include an intelligent hardware device, e.g., a central processing unit (CPU), a microcontroller, an application specific integrated circuit (ASIC), etc.

The identification verification module 625 may be configured to, in cooperation with the transaction request module 135-b and/or the security rule module 505-a, determine that the customer's identity is authenticated. That is, the module 625 may communicate with the transaction request module 135-b to retrieve the customer identifier code, query the transaction parameters records 150-b to retrieve additional information associated with the customer, and compare the information to authenticate the customer's identity. According to certain embodiments, the identification verification module 625 may be configured to communicate with the third party 115 (via the communications module 510-a) to verify the customer's identity. For example, the identification verification module 625 may retrieve the customer identifier code and the identification parameter from the transaction request, communicate this information to the third party 115, and receive confirmation from the third party 115 that the customer's identity has been confirmed. Once the customer's identity has been confirmed, the identification verification module may establish a confirmation signal indicating such confirmation.

The reporting module 630 may be configured to query one or more of the records 145-b, 150-b, and/or 155-b to retrieve information related to particular security rules, transactions, and/or customers. The reporting module 630 may establish one or more reports utilizing such information and provide the reports for viewing, downloading, printing, etc. According to certain embodiments, a remote user (e.g., the third party 115) may access the reports module 630 of the transaction security server 110-e via a series of one or more web pages presented via a web browser in order to customize, generate, and/or otherwise view the reports. Exemplary reports that the reports module 630 can provide include, but are not limited to, a report of every security rule for a given point-of-transaction device 105, a report of every transaction a given customer has engaged in, a report of every transaction for a given transaction type/transaction amount, a report of every transactions associated with a given point-of-transaction device 105, a report of every transaction that has been denied as a result of violation of one or more of the security rules and/or the authentication rule records 155-b, etc. Further, the reports can be based on one or more predetermined time periods.

The components of the transaction security servers 110 may be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the transaction security servers 110.

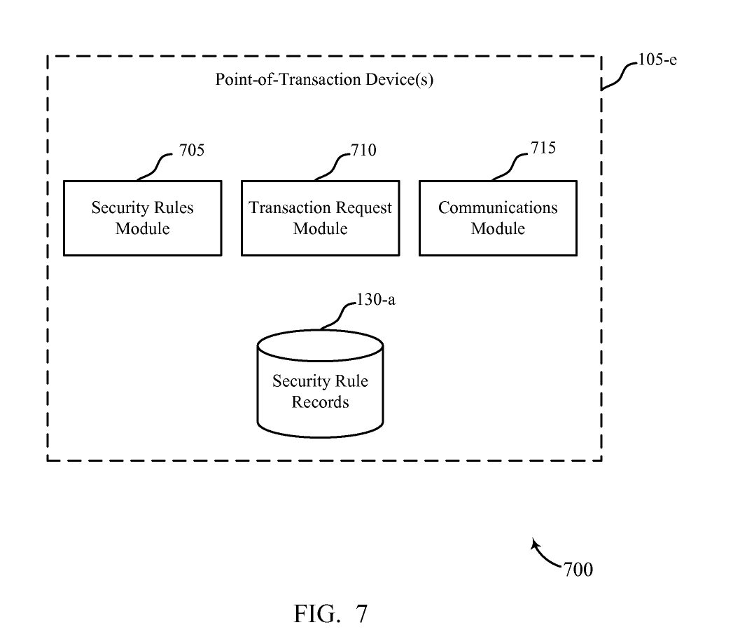

FIG. 7 a block diagram 700 of an example point-of-transaction device 105-e for transaction processing in accordance with various embodiments of the present disclosure. The point-of-transaction device 105-e may implement aspects and/or components of the point-of-transaction devices 105 of FIGS. 1-4 as well as implementing aspects of communication flows 200, 300, and/or 400. Aspects of the point-of-transaction device 110-e may be a processor.

Point-of-transaction device 105-e includes a security rules module 705, a transaction request module 710, a communications module 715, and a security rule records 130-a. The communications module 715 is configured to operatively communicate via one or more communications channels. The communications channels may be wired, wireless, or combinations of wired and wireless. Exemplary communications channels include a cellular communications network, a wireless local area network (e.g., WiFi) communications network, a series of interconnected computers, etc. According to certain embodiments, the communications module 715 is configured to operatively communicate with the transaction security server 110 and/or a user supervising agent 405.

The security rules module 705 may be configured to receive the selection of transaction parameters used to establish the security rule. For instance, the security rules module 705 may receive the selections from the user 125 and/or from the user supervising agent 405. The security rules module 705 may, based on the received selections, store the security rule that associates the transaction type and the triggering transaction amount with the at least one transaction parameter. The security rules module 705 may store the security rule in the security rules records 130-a. As can be appreciated, the security rule records 130-a may store each security rule that is applicable to the point-of-transaction device 105-e. The security rules may establish differing security requirements for different transaction type and/or transaction amounts. As such, the user 125 realizes greater flexibility to create, modify, and/or delete security rules in response to evolving needs.

The transaction request module 710 is configured to receive the certain parameters associated with a transaction. For instance, the transaction request module 710 may be configured to receive a transaction amount, a transaction type, a customer identifier code, and/or an identification parameter captured from a customer contemporaneously with the transaction. According to some embodiments, the user 125 and/or the customer 125 may enter the transaction parameters into the point-of-transaction device 105-e. Other aspects may provide for the point-of-transaction device 105-e to be configured to permit scanning an electro-magnetic stripe of a card to enter some of the transaction parameters. The transaction request module 710 may be configured to communicate the transaction request (via the communications module 715) to the transaction security server 110. For instance, the transaction request may form one or more data packets forming the transaction request in a manner that is retrievable by the transaction security server 110.

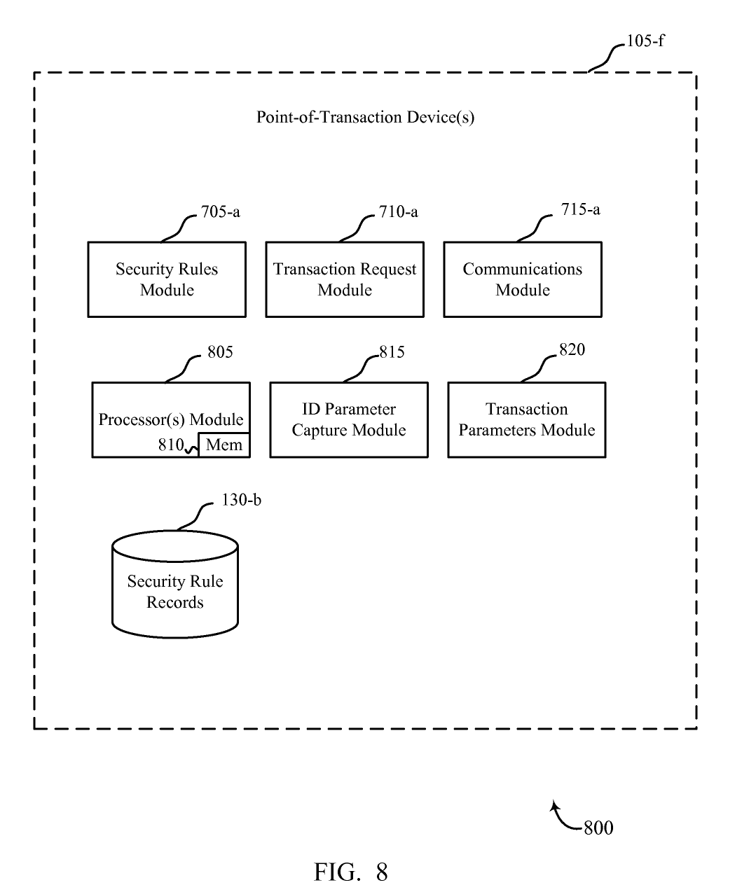

FIG. 8 is a block diagram 800 of another example point-of-transaction device 105-f for transaction processing in accordance with various embodiments of the present disclosure. The point-of-transaction device 105-f may implement aspects and/or components of the point-of-transaction devices 105 of FIG. 1-4 or 7 as well as implementing aspects of communication flows 200, 300, and/or 400. Aspects of the point-of-transaction device 110-f may be a processor.

The point-of-transaction device 105-f may include a security rules module 705-a, a transaction request module 710-a, a communications module 715-a, a processor module 805 having memory 810, an ID parameter capture module 815, a transaction parameters module 820, and a security rule records 130-b. The communications module 715-a may be configured to permit the point-of-transaction device 105-f to operatively communicate via one or more communications channels with the transaction security server 110 and/or the user supervising agent 405. The communications channels may be wired, wireless, or combinations of wired and wireless.

The security rules module 705-a may be configured to receive the selection of the transaction parameters, establish the security rule associating the triggering transaction amount and the transaction type with the at least one transaction parameter, and store the security rule in the security rule records 130-b. The transaction request module 710-a is configured to receive the parameters associated with a transaction, e.g., the transaction type, the transaction amount, the customer identifier code, and/or an identification parameter captured from a customer contemporaneously with the transaction. The transaction request module 710-a may be configured to communicate the transaction request (via the communications module 715-a) to the transaction security server 110. The transaction request module 710-a may also be configured to query the security rules records 130-b and determine if the transaction request complies with the applicable security rule.

The processor module 805 includes the memory 810. The memory 810 may include random access memory (RAM) and read-only memory (ROM). The memory 810 may store computer-readable, computer-executable software code containing instructions that are configured to, when executed, cause the processor module 805 to perform various functions described herein (e.g., transaction processing). Alternatively, the software may not be directly executable by the processor module 805 but may be configured to cause a computer (e.g., when compiled and executed) to perform functions described herein. The processor module 805 may include an intelligent hardware device, e.g., a central processing unit (CPU), a microcontroller, an application specific integrated circuit (ASIC), etc.

The ID parameter capture module 815 may be configured to capture the identification parameter contemporaneous to the transaction. According to some embodiments, the ID parameter capture module 815 may be in operative communication with one or more of an image capture device, a biometric capture device, and the like, either integral to the point-of-transaction device 105-f or as a peripheral component. The ID parameter capture module 815 may be configured to capture the identification parameter using one or more of said components and store information indicative of the captured data. Other aspects may provide for the ID parameter capture module 815 to be configured to capture an image of an identification card provided by the customer during the transaction. As can be appreciated, the captured identification parameter may be included in the transaction request and utilized by the transaction security server 110 to confirm the identity of the customer.

The transaction parameters module 820 may be configured to receive and store certain parameters associated with a transaction and/or the establishment of a security rule. For example, the transaction parameters module 820 may be configured to receive and store, for a given transaction, the transaction type, the transaction amount, the customer identifier code, and the like. Accordingly, the point-of-transaction device 105 may be configured to store at least some of the parameters for each transaction. According to another example, the transaction parameters module 820 may be configured to receive a selection, and store parameters associated with the security steps that are to be taken for differing transactions. That is, the transaction parameters module may query the security rule records 130-b during the secure transaction processing to retrieve the required security step for the instant transaction type/amount (as defined by the applicable security rule). When the security rule requires capturing an image of the customer for the transaction type/amount, the transaction parameters module may cooperate with the ID parameter capture module 815 to capture the image and provide the image to the transaction request module 710-a.

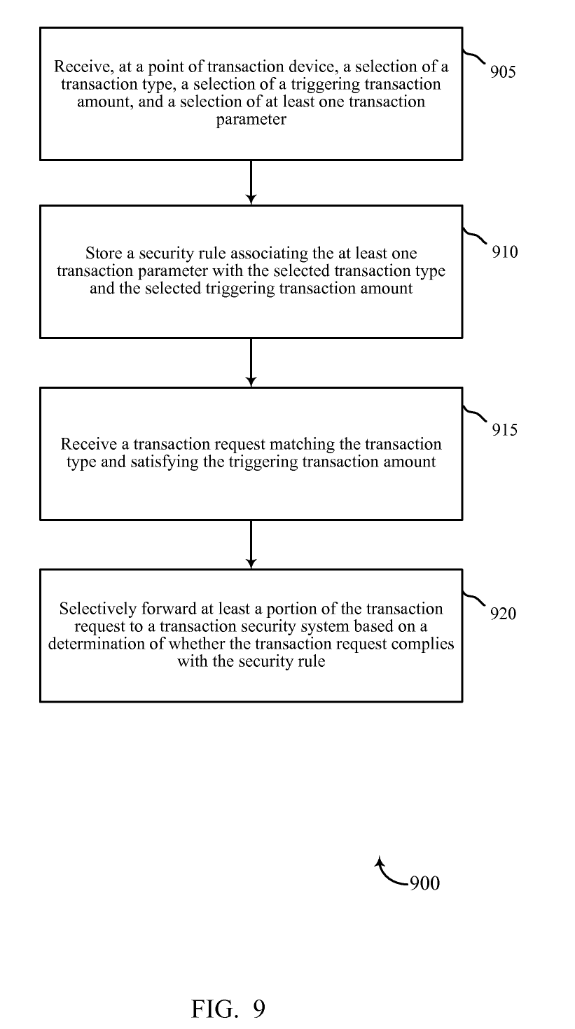

FIG. 9 is a flowchart of a method 900 for secure transaction processing in accordance with aspects of the present disclosure. Aspects of the method 900 may be performed by one or more of the devices 105, 110, and/or 115 of FIGS. 1-8. Similarly, the method 900 may implement aspects of the communication flows 200, 300, and/or 400. In one implementation, the processor module 615 of the transaction security server 110 may execute one or more sets of codes or computer executable instructions to control the functional elements of the transaction security server 110 to perform the functions described below. In another implementation, the processor module 805 of the point-of-transaction device 105 may execute one or more sets of codes or computer executable instructions to control the functional elements of the point-of-transaction device 105 to perform the functions described below. At block 905, a point-of-transaction device 105 receives a selection of a transaction type, a selection of a triggering transaction amount, and a selection of at least one transaction parameter. As discussed, the received selections may be used by the point-of-transaction device 105 to establish a security rule. At 910, the point-of-transaction device 105 stores the security rule that associates the at least one transaction parameter with the selected transaction type and the selected triggering transaction amount. Accordingly, the point-of-transaction device 105 has established a security rule that is to be applied to each transaction that matches the transaction type and that meets or exceeds the triggering transaction amount.

At block 915, the point-of-transaction device 105 receives a transaction request that matches the transaction type and satisfying the triggering transaction amount. For example, if the security rule is for a cash-based transaction type and for a triggering transaction amount of $100.00, a transaction request including transaction parameters associated with a cash-based transaction type and for a transaction amount of $105.00 would match the security rule. The point-of-transaction device 105 may then determine if the security response associated with that security rule has been satisfied with. For example, the point-of-transaction device 105 may, when the security rule requires capturing an image of the customer's identification card, determine whether the image has been captured. If so, the point-of-transaction device 105 forwards at least a portion of the transaction request to the transaction security server 110 based on the determination. As can be appreciated, the method 900 permits the user to establish one or more custom security rules to be applied to given transactions, receive the transaction requests and verify that the transaction request complies with the security rule, and forward the transaction request to the transaction security server 110 for further authorization and/or verification of the customer's identity.

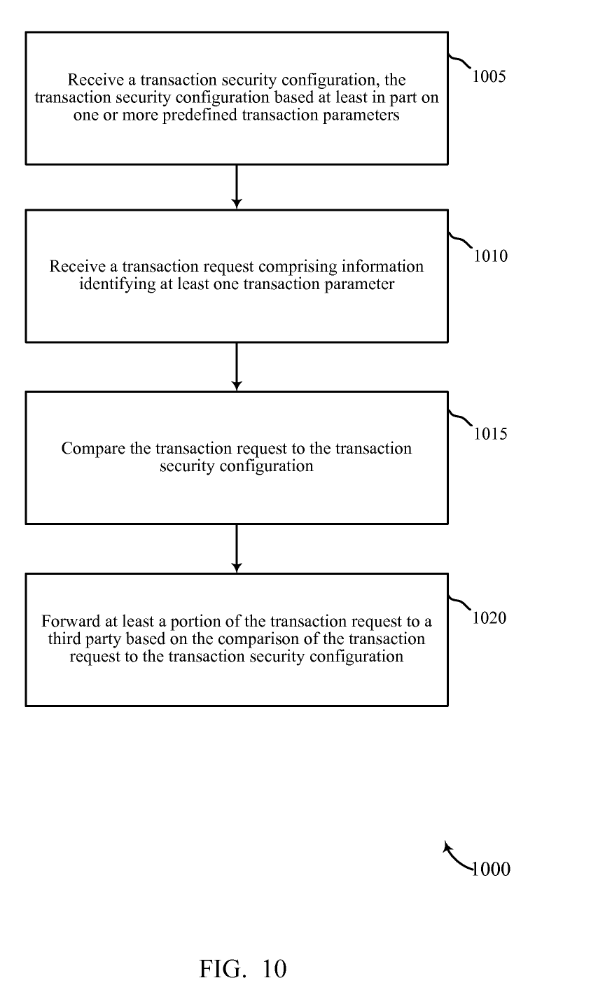

FIG. 10 is a flowchart of a method 1000 for transaction processing in accordance with aspects of the present disclosure. Aspects of the method 1000 may be performed by one or more of the devices 105, 110, and/or 115 of FIGS. 1-8. Similarly, the method 1000 may implement aspects of the communication flows 200, 300, and/or 400. In one implementation, the processor module 805 of the point-of-transaction device 105 may execute one or more sets of codes or computer executable instructions to control the functional elements of the point-of-transaction device 105 to perform the functions described below. In another implementation, the processor module 615 of the transaction security server 110 may execute one or more sets of codes or computer executable instructions to control the functional elements of the transaction security server 110 to perform the functions described below. At block 1005, a transaction security server 100 receives a transaction security configuration that is based on one or more predefined transaction parameters. The transaction security configuration may be received from the point-of-transaction device 105. The transaction security configuration may be one or more security rules established and/or stored by the point-of-transaction device 105. At 1010, the transaction security server 110 receives a transaction request. The transaction request may include information identifying at least one transaction parameter. According to certain embodiments, the transaction request may include a transaction type, a transaction amount, a customer identifier code identifying the customer to the transaction, and/or an identification parameter usable to confirm the identity of the customer.

At block 1015, the transaction security server 110 compares the transaction request to the transaction security configuration. As such, the transaction security server 110 ensures compliance with the security rule established by the point-of-transaction device 105. At 1020, the transaction security server 110 forwards at least a portion of the transaction request to a third party. The transaction security server 100 may forward the transaction request based on the comparison of the transaction request to the transaction security configuration. As discussed, the third party may provide further confirmation of the customer's identity and/or final approval of the transaction.

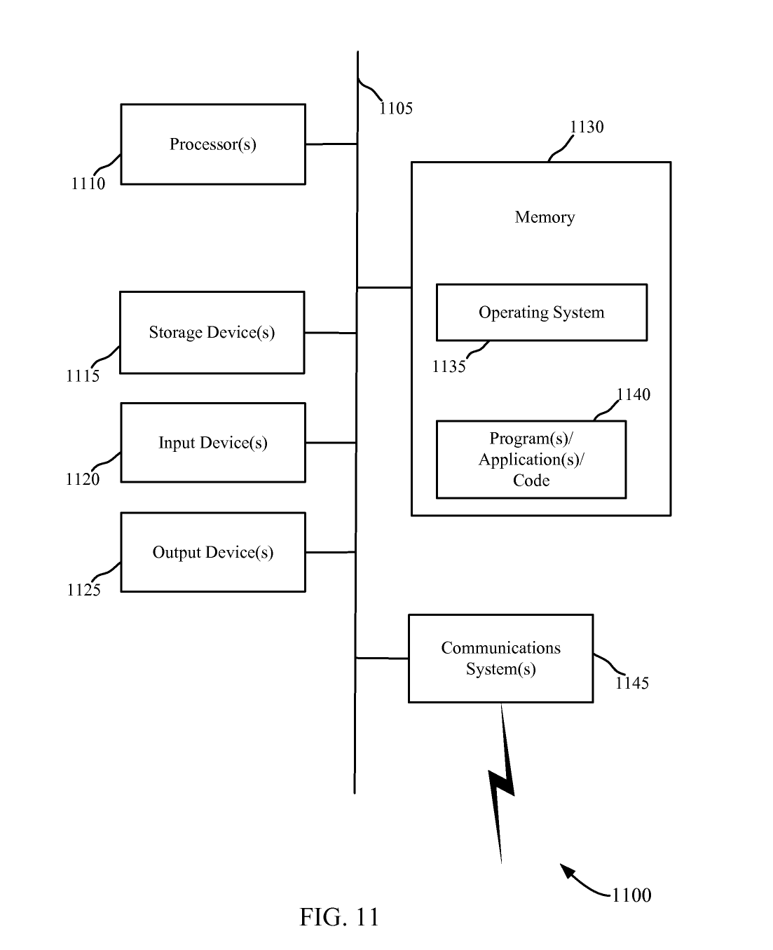

A device structure 1100 that may be used for a point-of-transaction device 105, a transaction security server 110, a third party 115, or other computing devices described herein, is illustrated with the schematic diagram of FIG. 11. This drawing broadly illustrates how individual system elements of each of the aforementioned devices may be implemented, whether in a separated or more integrated manner. The exemplary structure is shown comprised of hardware elements that are electrically coupled via bus 1105, including processor(s) 1110 (which may further comprise a DSP or special-purpose processor), storage device(s) 1115, input device(s) 1120, and output device(s) 1125. The storage device(s) 1115 may be a machine-readable storage media reader connected to any machine-readable storage medium, the combination comprehensively representing remote, local, fixed, or removable storage devices or storage media for temporarily or more permanently containing computer-readable information. The communications systems interface 1145 may interface to a wired, wireless, or other type of interfacing connection that permits data to be exchanged with other devices. The communications system(s) interface 1145 may permit data to be exchanged with a network.

The structure 1100 may also include additional software elements, shown as being currently located within working memory 1130, including an operating system 1135 and other code 1140, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of conducting transactions, comprising:
receiving, at a point of transaction device, a selection of a transaction type, a selection of a triggering transaction amount, and a selection of at least one transaction parameter;
storing a security rule associating the at least one transaction parameter with the selected transaction type and the selected triggering transaction amount;
receiving a transaction request matching the transaction type and satisfying the triggering transaction amount; and
selectively forwarding at least a portion of the transaction request to a transaction security system based on a determination of whether the transaction request complies with the security rule.

2. The method of claim 1, wherein determining whether the transaction complies with the security rule comprises:
determining whether the transaction request includes the at least one transaction parameter.

3. The method of claim 1, further comprising:
receiving a confirmation signal from the transaction security system based on an approval of the transaction request by a third party.

4. The method of claim 1, further comprising:
transmitting the security rule to the transaction security system.

5. The method of claim 4, wherein the transaction request matches a plurality of security rules, the method further comprising:
refraining from forwarding at least the portion of the transaction request to the transaction security system until determining that the transaction request complies with each of the plurality of security rules.

6. The method of claim 1, further comprising:
receiving a plurality of transaction security rules, each rule comprising a transaction parameter associated with a transaction type and a triggering transaction amount.

7. The method of claim 1, wherein the at least one transaction parameter comprises an identification parameter, the method further comprising:
receiving the identification parameter as part of the transaction request, the identification parameter identifying a party to the transaction; and
storing information associating the identity of the party with the transaction.

8. The method of claim 7, wherein the at least one transaction parameter further comprises an identification verification parameter, the method further comprising:
receiving the identification verification parameter as part of the transaction request, the identification verification parameter verifying the identity of the party to the transaction;
confirming, based on the identification verification parameter, that the identity of the party to the transaction matches the identification parameter.

9. The method of claim 1, wherein the at least one transaction parameter comprises one or more of a signature of a party to the transaction, a biometric identifier associated with the party to the transaction, a document associated with the transaction, or a document associated with the party to the transaction.

10. The method of claim 1, wherein the point of transaction device comprises a mobile device communicatively coupled with the transaction security system over a cellular network.

11. A method of conducting transactions comprising:
receiving a transaction security configuration, the transaction security configuration based at least in part on one or more predefined transaction parameters;
receiving a transaction request comprising information identifying at least one transaction parameter;
comparing the transaction request to the transaction security configuration; and
forwarding at least a portion of the transaction request to a third party based on the comparison of the transaction request to the transaction security configuration.

12. The method of claim 11, further comprising:
receiving an approval of the transaction request from the third party; and
sending a confirmation signal in response to the approval from the third party.

13. The method of claim 11, further comprising:
dynamically establishing one or more security requirements for each of at least one transaction type based on the predefined transaction parameters.

14. The method of claim 11, wherein comparing the transaction request to the transaction security configuration comprises:
identifying a transaction type associated with the transaction request;
identifying, based on the security requirements for the transaction type, at least one of the predefined transaction parameters associated with the transaction type; and
determining whether the transaction request includes the at least one of the predefined transaction parameters associated with the transaction type.

15. The method of claim 14, further comprising:
receiving a plurality of transaction security configurations;
wherein the plurality of transaction security configurations establishes a different set of one or more security requirements for each of a plurality of transaction types.

16. The method of claim 14, further comprising:
receiving an identification parameter included in the transaction request, the identification parameter identifying a party to the transaction; and
storing information associating the party with the transaction.

17. The method of claim 16, wherein the at least one transaction parameter further comprises an identification verification parameter, the method further comprising:
receiving the identification verification parameter as part of the transaction request, the identification verification parameter verifying the identity of the party to the transaction;
confirming, based on the identification verification parameter, that the identity of the party to the transaction matches the identification parameter.

18. The method of claim 11, wherein the point of transaction device comprises a mobile device communicatively coupled with the transaction security system over a cellular network.

19. An apparatus for conducting transactions comprising:
a processor;
memory in electronic communication with the processor; and
instructions being executable by the processor to,
receive, at a point of transaction device, a selection of a transaction type, a selection of a triggering transaction amount, and a selection of at least one transaction parameter;
store a security rule associating the at least one transaction parameter with the selected transaction type and the selected triggering transaction amount;
receive a transaction request matching the transaction type and satisfying the triggering transaction amount; and
selectively forward at least a portion of the transaction request to a transaction security system based on a determination of whether the transaction request complies with the security rule.

20. The apparatus of claim 19, wherein the instructions to determine whether the transaction complies with the security rule comprises instructions to:
determine whether the transaction request includes the at least one transaction parameter.

21. The apparatus of claim 19, further comprising instructions to:
receive a confirmation signal from the transaction security system based on an approval of the transaction request by a third party.

22. The apparatus of claim 19, further comprising instructions to:
receive a plurality of transaction security rules, each rule comprising a transaction parameter associated with a transaction type and a triggering transaction amount.

23. The apparatus of claim 19, wherein the at least one transaction parameter further comprises an identification verification parameter, the method further comprises instructions to:
receive the identification verification parameter as part of the transaction request, the identification verification parameter verifying the identity of the party to the transaction;
confirm, based on the identification verification parameter, that the identity of the party to the transaction matches the identification parameter.

24. An apparatus for conducting transactions comprising:
a processor;
memory in electronic communication with the processor; and
instructions being executable by the processor to,
receive a transaction security configuration, the transaction security configuration based at least in part on one or more predefined transaction parameters;
receive a transaction request comprising information identifying at least one transaction parameter;
compare the transaction request to the transaction security configuration; and
forward at least a portion of the transaction request to a third party based on the comparison of the transaction request to the transaction security configuration.

25. The apparatus of claim 24, further comprising instructions to:
dynamically establish one or more security requirements for each of at least one transaction type based on the predefined transaction parameters.

26. The apparatus of claim 24, wherein the instructions to compare the transaction request to the transaction security configuration further comprises instructions to:
identify a transaction type associated with the transaction request;
identify, based on the security requirements for the transaction type, at least one of the predefined transaction parameters associated with the transaction type; and
determine whether the transaction request includes the at least one of the predefined transaction parameters associated with the transaction type.

27. A system for conducting transactions comprising:
a point of transaction device configured to receive selections of a transaction type, a triggering transaction amount, and at least one transaction parameter, to store a security rule associating the transaction parameter with the selected transaction type and the selected triggering transaction amount, to receive a transaction request matching the transaction type and satisfying the triggering transaction amount, and to forward the transaction request; and
a transaction security server configured to receive the transaction request and the security rule, to determine whether the transaction request complies with the security rule, and to forward at least a portion of the transaction request to a third party based on the comparison.

28. The system of claim 27, the transaction security server being further configured to receive an approval of the transaction request from the third party and to send a confirmation signal to the point of transaction device in response to the approval signal from the third party.

29. The system of claim 27, further comprising:
a customer identification module in operative communication with the point of transaction device and configured to capture an identification parameter of a customer that is a party to the transaction.

30. The system of claim 29, wherein the identification parameter is a biometric parameter captured from the customer contemporaneous to the transaction.
